(19) United States
(12) Patent Application Publication
(10) Pub. No.: US 2026/0106679 A1
(43) Pub. Date: Apr. 16, 2026

(54) COMMUNICATION DEVICE AND METHOD USED TO LOCATE PER-TONE PER-LAYER COMPACT SEARCH REGIONS FOR MIMO DETECTION IN A MIMO-OFDM SYSTEM

(71) Applicant: Realtek Semiconductor Corp, HsinChu (TW)

(72) Inventor: Chun-Chieh Tseng, HsinChu (TW)

(73) Assignee: Realtek Semiconductor Corp, HsinChu (TW)

(21) Appl. No.: 19/329,589

(22) Filed: Sep. 16, 2025

(30) Foreign Application Priority Data
Oct. 11, 2024 (TW) 113138665

(51) Int. Cl. H04B 17/309; H04B 7/0413

(52) U.S. Cl. CPC H04B 17/346; H04B 7/0413

(57) ABSTRACT

A communication device includes: an inter-layer interference (ILI) removing circuit, for removing first ILI from a first observed signal, to generate a first interference-removed signal; a first determination circuit, coupled to the ILI removing circuit, for determining a first center of a first search region (SR) according to the first interference-removed signal; a second determination circuit, coupled to the first determination circuit, for determining a first size of the first SR according to a first Gaussian outage probability and a first signal-to-noise ratio (SNR); and a third determination circuit, coupled to the second determination circuit, for determining a first number of at least one first candidate symbol for the first interference-removed signal according to the first size of the first SR.

### BACKGROUND OF THE INVENTION

### 1. Field of the Invention

The present invention relates to a communication device and a method used in a wireless communication system, and more particularly, to a communication device and a method for locating per-tone per-layer compact search regions for multiple input multiple output (MIMO) detection in a MIMO orthogonal frequency division multiplexing (OFDM) system.

### 2. Description of the Prior Art

In a multiple input multiple output (MIMO) system communicating through a wireless channel, each antenna of a receiver simultaneously receives signals emitted from each antenna at the transmitter. As such, the inherent multipath diversity gain, antenna gain and potential beamforming gain will be increased and significantly improve the capacity and throughput of the MIMO system. An orthogonal frequency division multiplexing (OFDM) has been widely used to simplify complexity of channel equalization at the receiver. Multi-user transmission can be achieved via dynamic wireless resource scheduling. All of these apparent benefits make MIMO-OFDM become a mainstream architecture of a physical layer in modern communication systems. As the demands of system capacity and throughput get higher, however, the following system parameters are getting higher according, including the system bandwidth (proportional to total number of tones), modulation order, number of transmit and receive antennas, number of spatial streams. As such, more design efforts are paid per-tone per-layer in dealing with not only inter-layer-interference (ILI) but also a wider candidate search region for QAM-symbol detection. All of these factors make the detection complexity extremely high. To reduce complexity of MIMO detection in a MIMO-OFDM system, setting a compact search region (SR) per-tone per-layer with reduced number of candidate symbols becomes essentially critical.

### SUMMARY OF THE INVENTION

The present invention therefore provides a communication device and method for locating per-tone per-layer compact search regions for MIMO detection in a MIMO-OFDM system to solve the abovementioned problem.

A communication device comprises: an inter-layer interference (ILI) removing circuit, for removing first ILI from a first observed signal, to generate a first interference-removed signal; a first determination circuit, coupled to the ILI removing circuit, for determining a first center of a first search region (SR) according to the first interference-removed signal; a second determination circuit, coupled to the first determination circuit, for determining a first size of the first SR according to a first Gaussian outage probability and a first signal-to-noise ratio (SNR); and a third determination circuit, coupled to the second determination circuit, for determining a first number of at least one first candidate symbol for the first interference-removed signal according to the first size of the first SR.

A method for multiple input multiple output (MIMO) data detection comprises: removing first ILI from a first observed signal, to generate a first interference-removed signal; determining a first center of a first search region (SR) according to the first interference-removed signal; determining a first size of the first SR according to a first Gaussian outage probability and a first signal-to-noise ratio (SNR); and determining a first number of at least one first candidate symbol for the first interference-removed signal according to the first size of the first SR.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a schematic diagram of an interference-removed signal according to an example of the present invention.

FIG. 4 is a flowchart of a process according to an example of the present invention.

### DETAILED DESCRIPTION

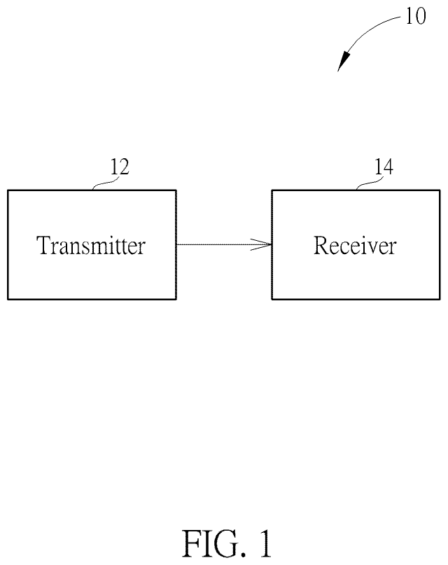

FIG. 1 is a schematic diagram of a communication system 10 according to an example of the present invention. The communication system 10 may be any communication system using an orthogonal frequency-division multiplexing (OFDM) technique (also termed a discrete multi-tone modulation (DMT) technique), and is composed of a transmitter 12 and a receiver 14. The communication system 10 may be any wired communication system such as an asymmetric digital subscriber line (ADSL) system, but is not limited herein. The communication system 10 may alternatively be any wireless communication system such as a wireless local area network (WLAN), a Digital Video Broadcasting (DVB) system, a Long Term Evolution (LTE) system, a Long Term Evolution-advanced (LTE-A) system or a fifth generation (5G) system, but is not limited herein. In addition, the transmitter 12 and the receiver 14 may be installed in a user equipment (UE), a mobile phone, a laptop, a personal computer, a tablet computer, an electronic book, a portable computer system, an access point (AP), a smart swatch, etc., but is not limited herein.

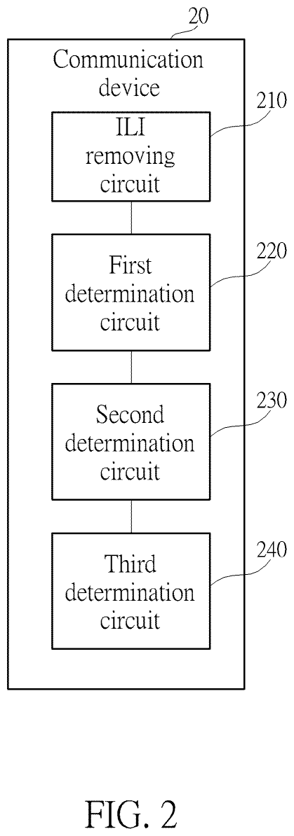

FIG. 2 is a schematic diagram of a communication device 20 according to an example of the present invention. The communication device 20 may be the receiver 14 in FIG. 1, and is used to perform data detection for a multiple input multiple output (MIMO) orthogonal frequency division multiplexing (OFDM) system. The communication device 20 comprises an inter-layer interference (ILI) removing circuit 210, a first determination circuit 220, a second determination circuit 230 and a third determination circuit 240. In detail, the ILI removing circuit 210 is configured to remove first ILI from a first observed signal, to generate a first interference-removed signal. The first determination circuit 220 is coupled to the ILI removing circuit 210, and is configured to determine a first center of a first search region (SR) (or a concise first SR) according to the first interference-removed signal. The second determination circuit 230 is coupled to the first determination circuit 220, and is configured to determine a first size of the first SR according to a first Gaussian outage probability and a first signal-to-noise ratio (SNR). The third determination circuit 240 is coupled to the second determination circuit 230, and is configured to determine a first number of at least one first candidate symbol (e.g. constellation) for the first interference-removed signal according to the first size of the first SR.

In one example, the communication device 20 further comprises a channel estimation circuit and/or a synchronization circuit (not shown in FIG. 2). The channel estimation circuit and/or the synchronization circuit are configured to process data received from the transmitter 12, to generate the observed signal. The channel estimation circuit or the synchronization circuit transmits the observed signal to the ILI removing circuit 210.

In one example, the communication device 20 further comprises a fourth determination circuit and a data detection circuit (not shown in FIG. 2). The fourth determination circuit is coupled to the third determination circuit 240, and is configured to determine the at least one first candidate symbol in the first SR according to the first center of the first SR and the first number of the at least one first candidate symbol. The data detection circuit is coupled to the fourth determination circuit, and is configured to detect the at least one first candidate symbol, to generate a first detected signal corresponding to the first observed signal.

In one example, the first observed signal comprises a MIMO-OFDM signal. In one example, the first observed signal comprises at least one first complex value. In one example, the at least one first complex value corresponds to at least one antenna of the communication device 20, respectively.

In one example, the first ILI comprises at least one second complex value. In one example, the at least one second complex value corresponds to at least one antenna of the communication device 20, respectively. In one example, each complex value of the at least one second complex value comprises a real value and an imaginary value. In one example, probabilities of the real value and the imaginary value present a Gaussian distribution.

In one example, the step of the ILI removing circuit 210 removing the first ILI from the first observed signal comprises: performing a sorted QR decomposition (SQRD) for the first observed signal according to a first channel matrix and a first observation vector, to remove the first ILI from the first observed signal. In one example, the first observed signal is a last entry of the first observation vector, and a first channel vector corresponding to the first observed signal is a last column vector of the first channel matrix.

In one example, the step of the first determination circuit 220 determining the first center of the first SR according to the first interference-removed signal comprises: performing a hard decision (HD) for the first interference-removed signal via a zero forcing (ZF) and a slicing, to determine the first center of the first SR. For example, the first center of the first SR is determined to be a candidate symbol closest to the first interference-removed signal.

In one example, the step of the second determination circuit 230 determining the first size of the first SR according to the first Gaussian outage probability and the first SNR comprises: determining the first Gaussian outage probability; determining a parameter corresponding to a Gaussian tail-end probability according to the first Gaussian outage probability; and determining the first size of the first SR according to the parameter and the first SNR. In one example, the first Gaussian outage probability is dynamically adjusted according to a current situation. In one example, the Gaussian tail-end probability is a Gaussian Q function. In one example, the first size of the first SR comprises a side length of the first SR. In one example, the first size of the first SR comprises half the side length of the first SR.

In one example, the first number of the at least one first candidate symbol is not greater than a threshold. In one example, the threshold is a modulation/demodulation order. For example, the modulation/demodulation scheme may be a Quadrature Amplitude Modulation (QAM), but is not limited herein. In one example, the communication device 20 operates in an Nr×Nt MIMO-OFDM system, wherein Nr is an antenna number of the communication device (e.g., the receiver 14 in FIG. 1), and Nt is an antenna number of a transmitting device (e.g., the transmitter 12 in FIG. 1) corresponding to the communication device. In one example, Nr and Nt are not smaller than N, and N is a number of spatial streams transmitted by the transmitting device. That is, the transmitting device must transmit N spatial streams, and the antenna number Nr of the communication device and the antenna number Nt of the transmitting device are greater than or equal to N. For brevity, the invention only discusses the N×N MIMO-OFDM system, i.e., Nt=N and Nr=N. The invention may apply to the Nr×Nt MIMO-OFDM system where Nt≥N and Nt≥N.

In one example, the ILI removing circuit 210 removes second ILI from a second observed signal, to generate a second interference-removed signal; the first determination circuit 220 determines a second center of a second SR (or a second concise SR) according to the second interference-removed signal; the second determination circuit 230 determines a second size of the second SR according to a second Gaussian outage probability and a second SNR; and the third determination circuit 240 determines a second number of at least one second candidate symbol for the second interference-removed signal according to the second size of the second SR. In one example, the fourth determination circuit determines the at least one second candidate symbol in the second SR according to the second center of the second SR and the second number of the at least one second candidate symbol; and the data detection circuit detects the at least one second candidate symbol, to generate a second detected signal corresponding to the second observed signal. That is, when multiple observed signals exist, the communication device 20 solves the SRs for the observed signals by turns to thereby reduce a number of candidate symbols for each observed signal. Similarly, if the third observed signal exists (i.e., N>3), the communication device 20 solves the third SR for the third observed signal, to reduce a third number of at least one third candidate symbols for the third observed signal.

Details of the second observed signal, the second ILI, the second interference-removed signal, the second SR, the second center, the second Gaussian outage probability, the second SNR, the second size, the at least one second candidate symbol and the second number can be known by referring to the examples of the first observed signal, the first ILI, the first interference-removed signal, the first SR, the first center, the first Gaussian outage probability, the first SNR, the first size, the at least one first candidate symbol and the first number. For example, the step of the ILI removing circuit 210 removing the second ILI from the second observed signal comprises: performing the SQRD for the second observed signal according to a second channel matrix and a second observation vector to thereby remove the second ILI from the second observed signal. The second observed signal is a last entry of the second observation vector, and a second channel vector corresponding to the second observed signal is a last column vector of the second channel matrix. Other examples are not narrated herein.

The following example is used for illustrating how the communication device 20 determines the SR to reduce a complexity of the MIMO data detection. In the following, it is assumed that the communication device 20 transmits two data streams and operates in a 2×2 MIMO system, the modulation/demodulation scheme is 16 QAM, and the modulation/demodulation order is 16. First, a per-tone channel matrix H and a per-tone observed signal vector y̅ are defined as follows:

$$H = [ {h}_{1} {h}_{2} ] = [ \begin{matrix}{h}_{11} & {h}_{12} \\ {h}_{21} & {h}_{22}\end{matrix} ] = Q \cdot R \qquad ( Eq . 1 )$$

$$\overline{y} = Hx + \overline{n} \qquad ( Eq . 2 )$$

In the equation (1), the per-tone channel matrix H can be decomposed into a unitary matrix Q and an upper triangular matrix R by performing the SQRD on the ILI removing circuit 210. The upper triangular matrix

$$R = [ \begin{matrix}{r}_{11} & {r}_{12} \\ 0 & {r}_{22}\end{matrix} ] ,$$

wherein r₁₁ and r₂₂ are real values and r₁₂ is a complex value. Q·Q^{H}=Q^{H}·Q=I. The matrix I is an identity matrix. The vector x is data transmitted by the transmitter, and the vector x=[x₁ x₂]T, wherein x₁ and x₂ are complex values. The vector n̅ is a per-tone noise. Thus, the observed signal vector y received by the ILI removing circuit 210 can be shown as follows:

$$\begin{matrix}y = [ \begin{matrix}{y}_{1} \\ {y}_{2}\end{matrix} ] = {Q}^{H} \cdot y = Rx + n \\ = [ \begin{matrix}{r}_{11} & {r}_{12} \\ 0 & {r}_{22}\end{matrix} ] \cdot [ \begin{matrix}{x}_{1} \\ {x}_{2}\end{matrix} ] + [ \begin{matrix}{n}_{1} \\ {n}_{2}\end{matrix} ] = [ \begin{matrix}{r}_{11} {x}_{1} + {r}_{12} {x}_{2} + {n}_{1} \\ {r}_{22} {x}_{2} + {n}_{2}\end{matrix} ]\end{matrix} \qquad ( Eq . 3 )$$

wherein n is noise vector, n≡[n₁ n₂]^{T}≡Q^{H}n̅, and n₁ and n₂ are complex values. The probabilities of the real part and the imaginary part in n₁ and n₂ are Gaussian distributed. In one example,

$$\begin{matrix}{n}_{i} ≡ {n}_{t}^{I} + \\ {jn}_{i}^{Q} ,\end{matrix}$$

wherein

$${n}_{i \sim}^{μ iid} N ( 0 , {σ}^{2} / 2 ) , i = 1 , 2 , μ = I or Q ,$$

and σ² is the power of n₁ and n₂. Accordingly, the SR of x₂ is a square. The ILI removing circuit 210 may obtain an interference-removed signal y̅₂ according to equation (Eq. 3), as described in the following equations (Eq. 4) and (Eq. 5).

$${y}_{2} = {r}_{22} {x}_{2} + {n}_{2} \qquad ( Eq . 4 )$$

$${y}_{2} ≡ \frac{{y}_{2}}{{r}_{22}} = {x}_{2} + \frac{{n}_{2}}{{r}_{22}} \qquad ( Eq . 5 )$$

It should be noted that the larger a value of r₂₂, the smaller a value of

$$\frac{{n}_{2}}{{γ}_{22}} .$$

Accordingly, the error between x₂ and the interference-removed signal y̅₂ becomes smaller, the variability of the interference-removed signal y̅₂ becomes smaller, and the SR of x₂ becomes smaller due to the smaller variability. In addition, the SQRD is necessary to ensure r₂₂≥r₁₁ to reduce the SR of x₂. Then, the first determination circuit 220 performs the HD (e.g., selects a candidate symbol closest to the interference-removed signal y̅₂ from M candidate symbols) via the ZF and the slicing, to generate a HD signal \hat{x}₂, as described in the following equation (Eq. 6):

$${\hat{x}}_{2} = slice ( {\overline{y}}_{2} ) \qquad ( Eq . 6 )$$

The first determination circuit 220 regards the HD signal \hat{x}₂ as the center of the SR. In addition, the second determination circuit 230 determines a Gaussian outage probability δ, and calculates a parameter β of a Gaussian tail-end probability Q(β) according to the Gaussian outage probability δ as follows:

$$δ = 1 - 2 Q ( β ) \qquad ( Eq . 7 )$$

wherein

$$Q ( β ) = \frac{1}{\sqrt{2 π}} \cdot {\int }_{β}^{∞} {e}^{- {t}^{2} / 2} d t .$$

Then, the third determination circuit 240 determines a size C of the SR (i.e., half the side length of the SR) according to the parameter β and a measured SNR η, as described in the following equations (Eq. 8) and (Eq. 9):

$${P}_{r} [ \vert {n}_{2}^{μ} \vert \leq C ] = δ = 1 - 2 Q ( β ) \qquad ( Eq . 8 )$$

$$C = \frac{β}{\sqrt{2 η}} \qquad ( Eq . 9 )$$

wherein

$$C > 0 , η = \frac{1}{{σ}^{2}} ,$$

and σ² is the power of the noise n₁ and n₂. Accordingly, the size C of the SR can be expressed as follows:

$$C = \frac{β σ}{\sqrt{2}} \qquad ( Eq . 10 )$$

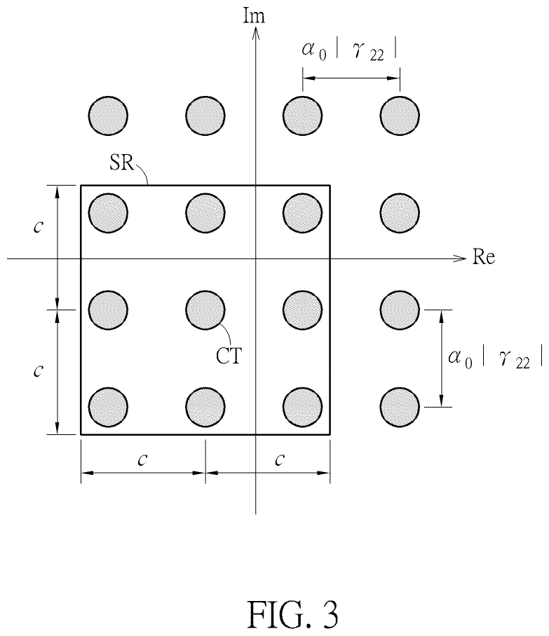

The third determination circuit 240 determines a number N_{C} of candidate symbols on half the side length of the SR according to the size C as follows:

$${N}_{C} = \frac{C}{{a}_{0} \vert {r}_{22} \vert} \qquad ( Eq . 11 )$$

wherein α₀ is a normalization factor of the 16 QAM to ensure E{|xᵢ|²}=1,∀i. α₀|r₂₂| is a distance between candidate symbols of the interference-removed signal y̅₂ for the 16 QAM (which can be known by referring to FIG. 3). Accordingly, a number N_{μ} of candidate symbols on the side length of the SR and a number Nₚ of candidate symbols in the SR can be expressed as follows:

$${N}_{μ} = 2 {N}_{C} + 1 \qquad ( Eq . 12 )$$

$${N}_{p} = Min [ floor ( {N}_{μ}^{2} ) , M ] \qquad ( Eq . 13 )$$

wherein M is a modulation/demodulation order. In one example, M=16. Accordingly, the number of candidate symbols of the interference-removed signal y̅₂ detected by the communication device 20 is not greater than the modulation/demodulation order (M=16). That is, the communication device 20 does not need to detect all M candidate symbols. The complexity for detecting the candidate symbols can be reduced to improve the power saving performance of the communication device 20.

Under the same situation, the above principles and steps for solving x₂ can be applied to solving x₁ after being processed according to the equations (Eq. 14) and (Eq. 15). The details are as follows.

A per-tone channel matrix H′ and a per-tone observed signal vector y̅′ are defined as follows:

$${H}^{′} = [ \begin{matrix}{h}_{2} & {h}_{1}\end{matrix} ] = [ \begin{matrix}{h}_{12} & {h}_{11} \\ {h}_{22} & {h}_{21}\end{matrix} ] = {Q}^{′} \cdot {R}^{′} \qquad ( Eq . 14 )$$

$${\overline{y}}^{′} = {[ \begin{matrix}{y}_{2} & {y}_{1}\end{matrix} ]}^{T} = {H}^{′} {x}^{′} + {\overline{n}}^{′} \qquad ( Eq . 15 )$$

In the equation (Eq. 14), the per-tone channel matrix H′ can be decomposed into a unitary matrix Q′ and an upper triangular matrix R′ by performing the SQRD on the ILI removing circuit 210. The upper triangular matrix

$${R}^{′} = [ \begin{matrix}{r}_{11}^{′} & {r}_{12}^{′} \\ 0 & {r}_{22}^{′}\end{matrix} ] ,$$

wherein r₁₁′ and r₂₂′ are real values and r₁₂′ is a complex value. Q′·Q′^{H}=Q′^{H}·Q′=I. The matrix I is the identity matrix. The vector x′ is data transmitted by the transmitter, wherein the vector x′=[x₂ x₁]^{T}, and x₁ and x₂ are complex values. The vector n̅′ is a per-tone noise. Thus, the observed signal vector y′ received by the ILI removing circuit 210 can be derived as follows:

$${y}^{′} = [ \begin{matrix}{y}_{2} \\ {y}_{1}\end{matrix} ] = \text{} {Q}^{′ H} \cdot {\overline{y}}^{′} = {Rx}^{′} + {n}^{′} = [ \begin{matrix}{r}_{11}^{′} & {r}_{12}^{′} \\ 0 & {r}_{22}^{′}\end{matrix} ] \cdot [ \begin{matrix}{x}_{2} \\ {x}_{1}\end{matrix} ] + [ \begin{matrix}{n}_{2} \\ {n}_{1}\end{matrix} ] = [ \begin{matrix}{r}_{11}^{′} {x}_{2} + {r}_{12}^{′} {x}_{1} + {n}_{2} \\ {r}_{22}^{′} {x}_{1} + {n}_{1}\end{matrix} ] \qquad ( Eq . 16 )$$

wherein n′ is noise vector, n′≡[n₂ n₁]^{T} ≡Q^{H}n̅′. The ILI removing circuit 210 may obtain an interference-removed signal y̅₁ according to equation (Eq. 16), as described in the following equations (Eq. 17) and (Eq. 18):

$${y}_{1} = {r}_{22}^{′} {x}_{1} + {n}_{1} \qquad ( Eq . 17 )$$

$${\overline{y}}_{1} = \frac{{y}_{1}}{{r}_{22}^{′}} = {x}_{1} + \frac{{n}_{1}}{{r}_{22}^{′}} \qquad ( Eq . 18 )$$

It should be noted that the larger a value of

$${r}_{22}^{′} ,$$

the smaller a value of

$$\frac{{n}_{1}}{{y}_{22}^{′}} .$$

Accordingly, the error between x₁ and the interference-removed signal y̅₁ becomes smaller, the variability of the interference-removed signal y̅₁ becomes smaller, and the SR of x₁ becomes smaller due to the smaller variability. In addition, the SQRD is necessary to ensure

$${r}_{22}^{′} \geq {r}_{11}^{′}$$

to reduce the SR of x₁. Then, the first determination circuit 220 performs the HD (e.g., selects a candidate symbol closest to the interference-removed signal y̅₁ from M candidate symbols) via the ZF and the slicing, to generate a HD signal \hat{x}₁, as described in the following equation (Eq. 19):

$${\hat{x}}_{1} = slice ( {\overline{y}}_{1} ) \qquad ( Eq . 19 )$$

The first determination circuit 220 regards the HD signal \hat{x}₁ as the center of the SR. In addition, the second determination circuit 230 determines a Gaussian outage probability δ′, and calculates a parameter β′ of a Gaussian tail-end probability Q(β′) according to the Gaussian outage probability δ′ as follows:

$${δ}^{′} = 1 - 2 Q ( {β}^{′} ) \qquad ( Eq . 20 )$$

wherein

$$Q ( {β}^{′} ) = \frac{1}{\sqrt{2 π}} \cdot {\int }_{{β}^{′}}^{∞} {e}^{- {t}^{2} / 2} d t .$$

Then, the third determination circuit 240 determines a size C′ of the SR (i.e., half the side length of the SR) according to the parameter β′ and a measured SNR η′, as described in the following equations (Eq. 21) and (Eq. 22):

$${P}_{r} [ \vert {n}_{1}^{μ} \vert \leq {C}^{′} ] = {δ}^{′} = 1 - 2 Q ( {β}^{′} ) \qquad ( Eq . 21 )$$

$${C}^{′} = \frac{{β}^{′}}{\sqrt{2 {η}^{′}}} \qquad ( Eq . 22 )$$

wherein

$${C}^{′} > 0 , η = \frac{1}{{σ}^{′2}} ,$$

and σ² is the power of the noise n₁ and n₂₂. Accordingly, the size C′ of the SR can be expressed as follows:

$${C}^{′} = \frac{{β}^{′} {σ}^{′}}{\sqrt{2}} \qquad ( Eq . 23 )$$

The third determination circuit 240 determines a number

$${N}_{C}^{′}$$

of candidate symbols on half the side length of the SR according to the size C′ as follows:

$${N}_{C}^{′} = \frac{{C}^{′}}{{α}_{0} \vert {r}_{22}^{′} \vert} \qquad ( Eq . 24 )$$

wherein

$${α}_{0} \vert {r}_{22}^{′} \vert$$

is a distance between candidate symbols of the interference-removed signal y̅₁ for the 16 QAM. Accordingly, a number

$${N}_{μ}^{′}$$

of candidate symbols on the side length of the SR and a number

$${N}_{p}^{′}$$

of candidate symbols in the SR can be expressed as follows:

$${N}_{μ}^{′} = 2 {N}_{C}^{′} + 1 \qquad ( Eq . 25 )$$

$${N}_{p}^{′} = Min [ floor ( {N}_{μ}^{′ 2} ) , M ] \qquad ( Eq . 26 )$$

Accordingly, the number of candidate symbols of the interference-removed signal y̅₁ detected by the communication device 20 is not greater than the modulation/demodulation order (M=16), i.e.,

$${N}_{p}^{′} \leq 16 .$$

That is, the communication device 20 does not need to detect all M candidate symbols. The complexity for detecting the candidate symbols can be reduced to improve the power saving performance of the communication device 20.

It should be noted that the equations (Eq. 1)-(Eq. 26) are an example applied to the 2×2 MIMO system, wherein the equations (Eq. 1)-(Eq. 13) are used for solving x₂ (i.e., solving the SR for x₂) and the equations (Eq. 14)-(Eq. 26) are used for solving x₁ (i.e., solving the SR for x₁). The operations of the above example may be applied to an N×N MIMO system. For example, the communication device solves the SRs of all xₙ by turns, wherein n=1˜N. The communication device shifts the n-th observed signal (or the n-th entry) (e.g., y₁ and y₂ in the above example) for the tone y to a last entry of the observed signal vector by turns, and shifts the n-th vector hₙ (e.g., h₁ and h₂ in the above example) to a last column vector of the per-tone channel matrix by turn. The SRs for all xₙ can be solved according to the operations of the above example.

The following example is used for illustrating how the communication device 20 determines the SR to reduce the complexity of the MIMO data detection. It is assumed that the communication device 20 transmits N data streams and operates in a N×N MIMO system. N is an integer greater than 1. First, a per-tone channel matrix H″ and a per-tone observed signal vector y″ are defined as follows:

$${H}^{″} = [ {h}_{1} {h}_{2} … {h}_{N - 1} {h}_{N} ] \qquad ( Eq . 27 )$$

$${y}^{″} = {[ {y}_{1} {y}_{2} … {y}_{N - 1} {y}_{N} ]}^{T} = {H}^{″} {x}^{″} + {n}^{″} \qquad ( Eq . 28 )$$

x″ is data transmitted by the transmitter, wherein x″=[x₁ x₂ . . . x_{N-1} x_{N}]^{T} and x₁-x_{N} are complex values. n″ is a per-tone noise vector, and n″=[n₁ n₂ . . . N_{N-1} n_{N}]^{T}. The statistical property (e.g., the variance) of n₁-n_{N} are the same, and they are independent and identically distributed (i.i.d.). When the communication device 20 intends to solve the SR for xₙ, the communication device performs the inter-layer swap on the per-tone channel matrix H″ and the per-tone observed signal vector y″ (e.g., swap hₙ and h_{N} in the per-tone channel matrix H″, and swap yₙ and y_{N} in the per-tone observed signal vector y″). The swapped per-tone channel matrix H̅″̅ and the swapped per-tone observed signal vector y̅″̅ are expressed as follows:

$$\overline{{H}^{″}} = [ {h}_{1} … {h}_{N} … {h}_{N - 1} {h}_{n} ] = {Q}^{″} \cdot {R}^{″} \qquad ( Eq . 29 )$$

$$\overline{{y}^{″}} = {[ {y}_{1} … {y}_{N} … {y}_{N - 1} … {y}_{n} ]}^{T} = \overline{{H}^{″}} \overline{{x}^{″}} + \overline{{n}^{″}} \qquad ( Eq . 30 )$$

In the equation (Eq. 29), the per-tone channel matrix H̅″̅ can be decomposed into a unitary matrix Q″ and an upper triangular matrix R″ by performing the SQRD on the ILI removing circuit 210. R″≡{rᵢⱼ}, wherein 1≤i,j≤N. If i<j, rᵢⱼ=0. In the equation (Eq. 30), x″=[x₁ . . . x_{N} . . . x_{N-1} xₙ]^{T}, and n″=[n₁ . . . n_{N} . . . n_{N-1} Nₙ]^{T}. In one example, the inter-layer swap may be performed on h₁ . . . h_{N} . . . h_{N-1} in the equation (Eq. 29), and the inter-layer swap may be performed on y₁ . . . y_{N} . . . y_{N-1} in the equation (Eq. 30). This can reduce the size of the SR. That is, there are various ways for the communication device 20 to perform the inter-layer swap. For example, when the communication device 20 intends to solve the SR for xₙ, the communication device 20 swaps hₙ and h_{N} in the per-tone channel matrix H″, then swaps h₁ and h_{N} in the per-tone channel matrix H″, and accordingly processes the per-tone observed signal vector y″. For example, when the communication device 20 intends to solve the SR for xₙ, the communication device 20 swaps hₙ and h_{N} in the per-tone channel matrix H″, then swaps h₁ and h_{N-1} in the per-tone channel matrix H″, and accordingly processes the per-tone observed signal vector y″.

The subsequent operations of the equation (Eq. 30) can be known by referring to the equations (Eq. 3)-(Eq. 13) and their related descriptions, and are not narrated herein. Thus, the communication device may solve the SRs for all xₙ by swapping the column vectors in the per-tone channel matrix H″ and the entries in the per-tone observed signal vector y″ by turns. It should be noted that the communication device 20 may obtain a different swapped per-tone channel matrix H̅″̅ via different applications of the inter-layer swap, and may further calculate different upper triangular matrices R″ and different values of r_{NN}. The larger the values of the upper triangular matrix R″ and r_{NN}, the smaller the error between xₙ and the interference-removed signal y̅ₙ. Accordingly, the variability of the interference-removed signal y̅ₙ becomes smaller, and the SR of x₂ becomes smaller. The communication device 20 may calculate a maximum r_{NN} by performing the inter-layer swap on the per-tone channel matrix H″ and the per-tone observed signal vector y″ in different ways, in order to reduce the size of the SR.

FIG. 3 is a schematic diagram of an interference-removed signal y̅₂ according to an example of the present invention. In FIG. 3, a horizontal axis is a real value Re{y̅₂̅}, and a vertical axis is an imaginary value Im{y̅₂̅}. Sixteen points in FIG. 3 are candidate symbols of the interference-removed signal y̅₂ for the 16 QAM. A distance between the candidate symbols is α₀|r₂₂|. According to the above example, the communication device 20 determines the center CT (e.g., the HD signal x₂) and the size C of the SR. The communication device 20 may obtain the SR SR, after determining the center CT and the size C of the SR. the communication device 20 only detects the candidate symbols in the SR SR, and thus the number of candidate symbols to be detected is reduced.

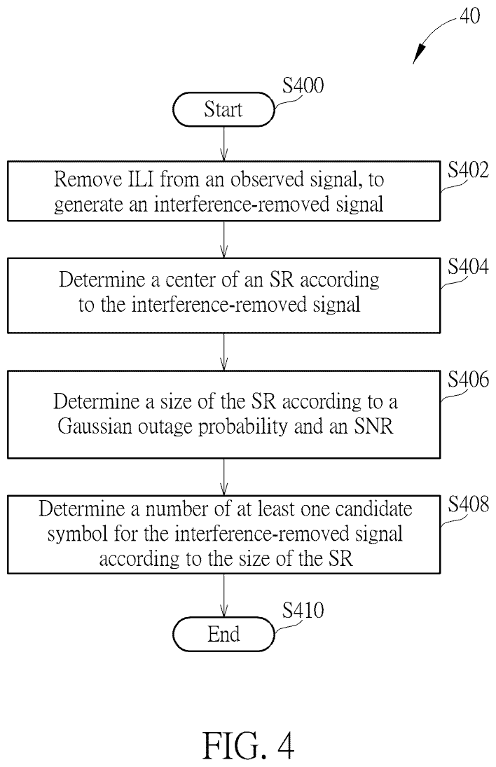

Operations of the communication device 20 in the above examples can be summarized into a process 40 for a MIMO data detection as shown in FIG. 4. The process 40 includes the following steps:
Step S400: Start.
Step S402: Remove ILI from an observed signal, to generate an interference-removed signal.
Step S404: Determine a center of an SR according to the interference-removed signal.
Step S406: Determine a size of the SR according to a Gaussian outage probability and an SNR.
Step S408: Determine a number of at least one candidate symbol for the interference-removed signal according to the size of the SR.
Step S410: End.

The process 40 is used for illustrating the operations of the communication device 20. Detailed description and variations of the process 40 can be known by referring to the previous description, and are not narrated herein.

The terms “first” and “second” described above are used to distinguish relevant statements, and are not used to limit an order of relevant statements. The operation “determine” described above may be replaced by the operation “compute”, “calculate”, “obtain”, “generate”, “output, “use”, “choose/select”, “decide” or “is configured to”. The operation “detect” described above may be replaced by the operation “check”, “monitor”, “receive”, “sense” or “obtain”. The phrase “according to” described above may be replaced by “via”, “by using” or “in response to”. The term “corresponding to” described above may be replaced by “of” or “associated with”. The term “comprise” described above may be replaced by “is”.

It should be noted that there are various possible realizations of the communication device 20 (including the ILI removing circuit 210, the first determination circuit 220, the second determination circuit 230 and the third determination circuit 240). For example, the circuits mentioned above may be integrated into one or more circuits. In addition, the communication device 20 and the circuits in the communication device 20 may be realized by hardware (e.g., circuits), software, firmware (known as a combination of a hardware device, computer instructions and data that reside as read-only software on the hardware device), an electronic system or a combination of the devices mentioned above, but are not limited herein.

To sum up, the present invention provides a communication device and a method. The communication device determines an SR, and performs the data detection only on candidate symbols in the SR. Thus, the communication device does not detect all candidate symbols, thereby reducing the complexity of the MIMO data detection and saving the resources of the communication device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device, comprising:
an inter-layer interference (ILI) removing circuit, for removing first ILI from a first observed signal, to generate a first interference-removed signal;
a first determination circuit, coupled to the ILI removing circuit, for determining a first center of a first search region (SR) according to the first interference-removed signal;
a second determination circuit, coupled to the first determination circuit, for determining a first size of the first SR according to a first Gaussian outage probability and a first signal-to-noise ratio (SNR); and
a third determination circuit, coupled to the second determination circuit, for determining a first number of at least one first candidate symbol for the first interference-removed signal according to the first size of the first SR.

2. The communication device of claim 1, further comprising:
a fourth determination circuit, coupled to the third determination circuit, for determining the at least one first candidate symbol in the first SR according to the first center of the first SR and the first number of the at least one first candidate symbol; and
a data detection circuit, coupled to the fourth determination circuit, for detecting the at least one first candidate symbol, to generate a first detected signal corresponding to the first observed signal.

3. The communication device of claim 1, wherein the first observed signal comprises a multiple input multiple output (MIMO) orthogonal frequency division multiplexing (OFDM) signal.

4. The communication device of claim 1, wherein the first observed signal comprises at least one first complex value, and the at least one first complex value corresponds to at least one antenna of the communication device, respectively.

5. The communication device of claim 1, wherein the first ILI comprises at least one second complex value, and the at least one second complex value corresponds to at least one antenna of the communication device, respectively.

6. The communication device of claim 5, wherein each complex value of the at least one second complex value comprises a real value and an imaginary value, and probabilities of the real value and the imaginary value present a Gaussian distribution.

7. The communication device of claim 1, wherein the step of the ILI removing circuit removing the first ILI from the first observed signal comprises:
performing a sorted QR decomposition (SQRD) for the first observed signal according to a first channel matrix and a first observation vector, to remove the first ILI from the first observed signal;
wherein the first observed signal is a last entry of the first observation vector, and a first channel vector corresponding to the first observed signal is a last column vector of the first channel matrix.

8. The communication device of claim 1, wherein the step of the first determination circuit determining the first center of the first SR according to the first interference-removed signal comprises:
performing a hard decision (HD) for the first interference-removed signal via a zero forcing (ZF) and a slicing, to determine the first center of the first SR.

9. The communication device of claim 1, wherein the step of the second determination circuit determining the first size of the first SR according to the first Gaussian outage probability and the first SNR comprises:
determining the first Gaussian outage probability;
determining a parameter corresponding to a Gaussian tail-end probability according to the first Gaussian outage probability; and
determining the first size of the first SR according to the parameter and the first SNR.

10. The communication device of claim 1, wherein the first number of the at least one first candidate symbol is not greater than a threshold.

11. The communication device of claim 1, wherein the communication device operates in an Nr×Nt MIMO-OFDM system, Nr is an antenna number of the communication device, Nt is an antenna number of a transmitting device corresponding to the communication device, Nr and Nt are not smaller than N, and N is a number of spatial streams transmitted by the transmitting device.

12. The communication device of claim 1, wherein the ILI removing circuit removes second ILI from a second observed signal, to generate a second interference-removed signal; the first determination circuit determines a second center of a second SR according to the second interference-removed signal; the second determination circuit determines a second size of the second SR according to a second Gaussian outage probability and a second SNR; and the third determination circuit determines a second number of at least one second candidate symbol for the second interference-removed signal according to the second size of the second SR.

13. The communication device of claim 12, wherein the fourth determination circuit determines the at least one second candidate symbol in the second SR according to the second center of the second SR and the second number of the at least one second candidate symbol; and the data detection circuit detects the at least one second candidate symbol, to generate a second detected signal corresponding to the second observed signal.

14. The communication device of claim 12, wherein the step of the ILI removing circuit removing the second ILI from the second observed signal comprises:
performing the SQRD for the second observed signal according to a second channel matrix and a second observation vector, to remove the second ILI from the second observed signal;
wherein the second observed signal is a last entry of the second observation vector, and a second channel vector corresponding to the second observed signal is a last column vector of the second channel matrix.

15. A method for multiple input multiple output (MIMO) data detection, comprising:
removing first ILI from a first observed signal, to generate a first interference-removed signal;
determining a first center of a first search region (SR) according to the first interference-removed signal;
determining a first size of the first SR according to a first Gaussian outage probability and a first signal-to-noise ratio (SNR); and
determining a first number of at least one first candidate symbol for the first interference-removed signal according to the first size of the first SR.

16. The method of claim 15, further comprising:
determining the at least one first candidate symbol in the first SR according to the first center of the first SR and the first number of the at least one first candidate symbol; and
detecting the at least one first candidate symbol, to generate a first detected signal corresponding to the first observed signal.

17. The method of claim 15, wherein the step of removing the first ILI from the first observed signal comprises:
performing a sorted QR decomposition (SQRD) for the first observed signal according to a first channel matrix and a first observation vector, to remove the first ILI from the first observed signal;
wherein the first observed signal is a last entry of the first observation vector, and a first channel vector corresponding to the first observed signal is a last column vector of the first channel matrix.

18. The method of claim 15, wherein a communication device performing the method operates in an Nr×Nt MIMO-OFDM system, Nr is an antenna number of the communication device, Nt is an antenna number of a transmitting device corresponding to the communication device, Nr and Nt are not smaller than N, and N is a number of spatial streams transmitted by the transmitting device.

19. The method of claim 15, further comprising:
removing second ILI from a second observed signal, to generate a second interference-removed signal;
determining a second center of a second SR according to the second interference-removed signal;
determining a second size of the second SR according to a second Gaussian outage probability and a second SNR; and
determining a second number of at least one second candidate symbol for the second interference-removed signal according to the second size of the second SR.

20. The method of claim 19, wherein the step of removing the second ILI from the second observed signal comprises:
performing the SQRD for the second observed signal according to a second channel matrix and a second observation vector, to remove the second ILI from the second observed signal;
wherein the second observed signal is a last entry of the second observation vector, and a second channel vector corresponding to the second observed signal is a last column vector of the second channel matrix.
